(19) United States
(12) Patent Application Publication
(10) Pub. No.: US 2015/0296710 A1
(43) Pub. Date: Oct. 22, 2015

(54) Fruit Collecting Device

(71) Applicant: Muoi Tia, Savage, MN (US)

(72) Inventor: Muoi Tia, Savage, MN (US)

(21) Appl. No.: 14/692,903

(22) Filed: Apr. 22, 2015

Related U.S. Application Data
(60) Provisional application No. 61/982,644, filed on Apr. 22, 2014.

(51) Int. Cl. A01D 46/247

(52) U.S. Cl. CPC A01D 46/247

(57) ABSTRACT

A fruit collecting device for picking fruit from the branches of a tree. The fruit collecting device includes an elongated handle, wherein the handle is preferably telescopic so that it can be adjusted to a desired length. A first end of the handle includes a cage having an opening thereon, wherein the cage includes an interior volume suitable for storing or holding fruit. The opening includes one or more sharp or serrated edges for severing the stem of a piece of fruit. In this way, the user can maneuver the cage so that a piece of fruit is positioned through the opening and within the cage, and can then move the device such that the serrated edges of the opening cuts the stem, causing the piece of fruit to fall into the cage.

### CROSS REFERENCE TO RELATED APPLICATION

This application claims the benefit of U.S. Provisional Application No. 61/982,644 filed on Apr. 22, 2014. The above identified patent application is herein incorporated by reference in its entirety to provide continuity of disclosure.

### BACKGROUND OF THE INVENTION

1. Field of the Invention

The present invention relates to a fruit collecting device. More specifically, the present invention provides a fruit collecting device for helping a user to collect fruit from high branches on a tree. The fruit collecting device comprises an elongated handle having a cage on an end thereof, wherein the cage includes an opening through which one or more pieces of fruit can be inserted into the cage. The opening further includes serrated edges for cutting the stem of a piece of fruit.

Many types of fruit grow on trees, such as apples, pears, oranges, and lemons, among others. Collecting the fruit from the trees can be difficult and time consuming, as much of the fruit is located on high branches that cannot be reached by a person standing on the ground. As a result, people may use ladders in order to reach fruit on high branches. However, climbing a ladder in order to pick fruit can be dangerous, and the ground around the tree may not be level. Alternatively, some people may climb the tree in order to gain access to high branches. Again, climbing the tree can be dangerous and the person may have difficulty climbing up the tree to access the fruit, and may have further difficulty climbing down the tree while holding one or more pieces of fruit.

Further, many people pick fruit by hand which can be difficult and time consuming. The person must grasp the piece of fruit and sever or cut the stem of the fruit in order to separate the fruit from the tree. The user may cut or scrape his or her hands while grasping the branches and severing the stems of the fruit. Additionally, picking pieces of fruit one by one is slow and inefficient, requiring the user to spend more time picking fruit. Thus, a device for allowing a user to more easily and safely pick fruit from the high branches of a tree is desired.

Devices have been disclosed in the prior art that relate to fruit collecting apparatuses. These include devices that have been patented and published in patent application publications. These devices generally relate to collection devices adapted to help a user to remove fruit from trees. Some devices provide fruit collecting or picking devices having jaws that can be actuated in order to remove a piece of fruit from a tree, such as U.S. Pat. No. 2,507,655, U.S. Pat. No. 57,731, U.S. Pat. No. 435,206, U.S. Pat. No. 978,683, and U.S. Pat. No. 4,615,555. Other devices provide fruit picking devices having scissor-like arms that can be used to remove fruit in a twisting motion, such as U.S. Pat. No. 7,076,937.

These prior art devices have several known drawbacks. The devices in the prior art require the user to actuate a pair of jaws located on the end of an elongated tool. Actuating jaws can be inconvenient and it can be hard for the user to operate the jaws while aligning the fruit picking device in the proper manner. Further, the user risks damaging the fruit if he or she does not properly align the jaws with the stem of the fruit. In contrast, the present invention provides an elongated handle having a cage on an end thereof, wherein the cage comprises an interior volume for storing fruit and further includes an opening through which a piece of fruit can enter the interior volume thereof. The opening of the cage has at least one serrated edge for cutting the stem of a piece of fruit in order to remove the fruit from the tree.

In light of the devices disclosed in the prior art, it is submitted that the present invention substantially diverges in design elements from the prior art and consequently it is clear that there is a need in the art for an improvement to existing fruit collecting devices. In this regard the instant invention substantially fulfills these needs.

### SUMMARY OF THE INVENTION

In view of the foregoing disadvantages inherent in the known types of fruit collecting devices now present in the prior art, the present invention provides a new fruit collecting device, wherein the same can be utilized for providing convenience for the user when collecting fruit from the high branches of a tree.

It is therefore an object of the present invention to provide a new and improved fruit collecting device that has all of the advantages of the prior art and none of the disadvantages.

It is another object of the present invention to provide a fruit collecting device that comprises an elongated handle having a cage on a first end thereof, wherein said cage includes an opening and an interior volume in which fruit can be collected and stored.

Another object of the present invention is to provide a fruit collecting device comprising an elongated handle having a cage with an opening, wherein the opening comprises at least one serrated edge adapted to sever the stem of a piece of fruit from a branch.

An additional object of the present invention is to provide a fruit collecting device comprising a cage composed of a plurality of curved wires.

Yet another object of the present invention is to provide a fruit collecting device having an elongated handle, wherein the elongated handle is telescopic such that the elongated handle can be adjusted in length.

A further object of the present invention is to provide a fruit collecting device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the fruit collecting device.

FIG. 2 a close-up view of the cage of the fruit collecting device.

FIG. 3 a perspective view of the fruit collecting device in use.

### DETAILED DESCRIPTION OF THE INVENTION

Reference is made herein to the attached drawings. Like reference numerals are used throughout the drawings to depict like or similar elements of the fruit collecting device. For the purposes of presenting a brief and clear description of the present invention, the preferred embodiment will be discussed as used for collecting fruit from the high branches of a tree. The figures are intended for representative purposes only and should not be considered to be limiting in any respect.

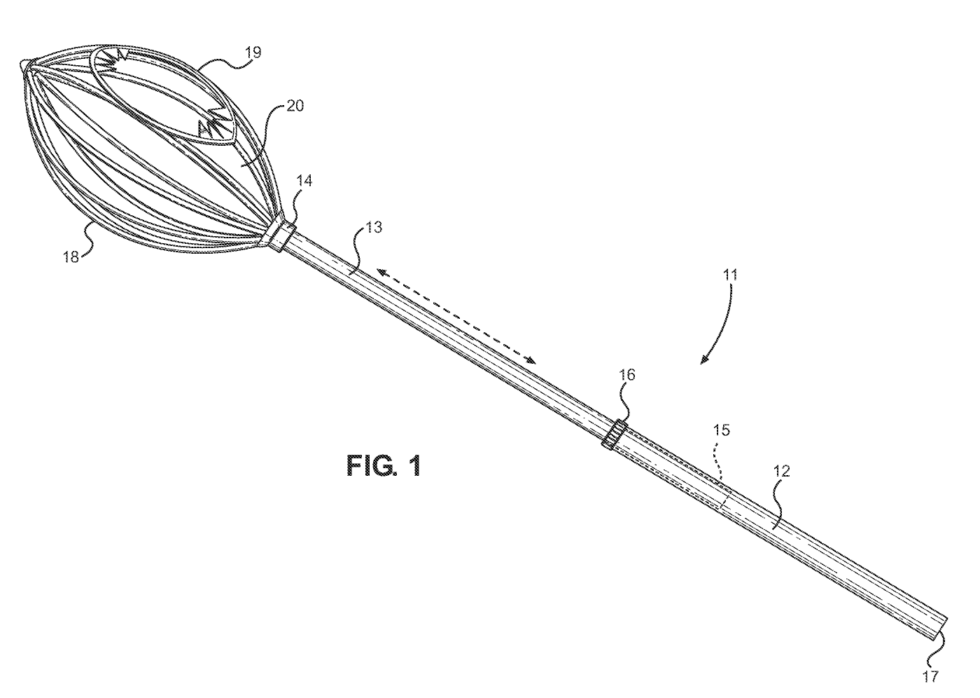

Referring now to FIG. 1, there is shown a perspective view of an embodiment of the fruit collecting device. The fruit collecting device 11 comprises an elongated handle having a first end and a second end, wherein the first end comprises a cage 18 thereon. The handle is preferably cylindrical in construction and is substantially linear. However, in alternate embodiments the handle may have a square cross sectional area, among other shapes. The handle is preferably composed of a durable, lightweight material such as aluminum or a hard plastic.

The handle is preferably telescopic and includes a first section 12 and second section 13 slidably inserted in the first section 12. The first section 12 is tubular and includes a hollow interior volume. The first section 12 includes an open first end 16 and a closed second end 17. The second section 13 is also tubular and is sized so as to fit within the interior volume of the first section 12. The second section 13 comprises a first end 15 that is inserted within the open first end 16 of the first section 12, and the second section 13 further includes a second end 14 to which the cage 18 is permanently attached. Thus the user can extend the second section 13 from the first section 12 to elongate the handle in order to reach higher areas. A locking mechanism is provided for securing the handle at a desired length.

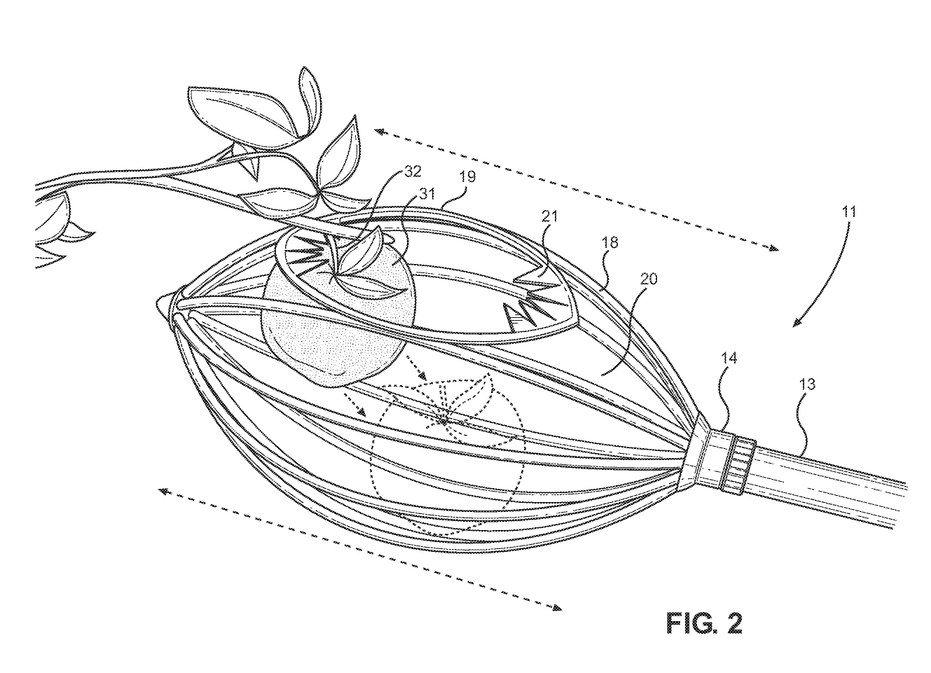

Referring now to FIG. 2, there is shown a close-up view of the cage of the fruit collecting device. The cage 18 disposed on the first end of the handle comprises an opening 19 providing access to the interior volume 20 of the cage 18. In the illustrated embodiment, the cage 18 comprises a prolate spheroid shape, wherein the longitudinal axis of the cage 18 is aligned with the longitudinal axis of the handle 13. The elongated shape of the cage 18 allows the cage 18 to fit between branches and reach into tight and narrow places in order to improve maneuverability. Further, the elongated shape of the cage 18 helps to increase the size of the interior volume so that more fruit can be stored therein. In alternate embodiments, the cage 18 comprises a spherical shape. The use of a cage 18 with a curved construction helps to prevent the formation of corners and allows the cage 18 to contour more closely to the rounded shape of most fruits, such as apples and oranges.

The cage 18 is preferably composed of a plurality of curved wires that provide a prolate spheroid shape. The curved wires are spaced at a fixed interval so that there is open space between each wire. The wires are spaced such that pieces of fruit are unable to pass therethrough. The use of wires allows the cage 18 be more easily maneuvered around a tree's branches, as a solid cage may be more likely to become stuck on a branch, whereas the spaces between the wires helps to prevent such an occurrence.

The opening 19 is preferably an oval shape, however in alternate embodiments the opening 19 may be a circular shape. The opening 19 is sized so as to allow fruit to pass therethrough, but is not so large as to allow the fruit collected within the interior volume of the cage 18 to easily escape through the opening 19. The opening 19 comprises a perimeter having at least one serrated edge 21 thereon. The serrated edge 21 is oriented inward towards the center of the opening 19. The serrated edge 21 is adapted for use in severing or cutting the stem 32 of a piece of fruit 31 that the user is collecting. In the illustrated embodiment, a first serrated edge 21 is located on a first side of the opening 19 while a second serrated edge 21 is located on a second side of the opening 19, wherein the second side of the opening 19 is opposite the first side of the opening 19. This allows the user to sever the stem of a piece of fruit by moving the cage 18 in an upward or downward motion so that the serrated edges 21 engage the stem.

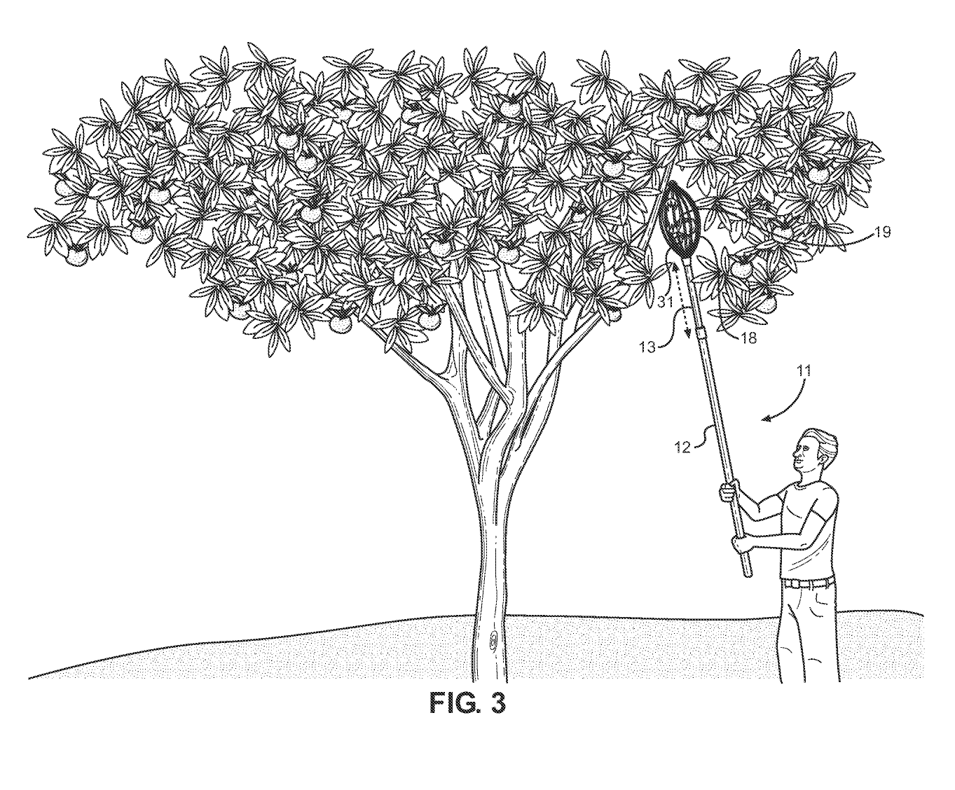

Referring now to FIG. 3, there is shown a perspective view of the fruit collecting device in use. In operation, the user can adjust the handle to the desired length for removing fruit from a tree by sliding the second section 13 of the handle within the first section 12 thereof. The user can then hold a first end of the handle and can maneuver the cage 18 towards a piece of fruit 31 desired to be collected. The user can align the opening 19 of the cage 18 with a piece of fruit 31 and can insert the fruit 31 within the cage 18. Once the fruit 31 is within the cage 18, the user can move the device 11 so that the stem of the fruit 31 contacts the serrated edge of the opening 19, severing the stem and causing the fruit 31 to fall within the cage for storage. The user can continue to remove fruit from the tree in this fashion until the cage 18 is filled with fruit. The user can then lower the cage 18 to ground-level and remove the fruit from the cage through the opening 19 thereon.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fruit collecting device, comprising:
an elongated handle having a first end and a second end;
a cage disposed on said first end of said elongated handle, wherein said cage comprises an opening and an interior volume;
wherein a perimeter of said opening comprises at least one serrated edge.

2. The fruit collecting device of claim 1, wherein said elongated handle is telescopic and comprises a first section and a second section slidably disposed within said first section.

3. The fruit collecting device of claim 1, wherein said cage is composed of a plurality of rigid wires.

4. The fruit collecting device of claim 1, wherein said cage comprises a prolate spheroid shape.

5. The fruit collecting device of claim 1, wherein said opening comprises an oval shape.

6. The fruit collecting device of claim 1, wherein said opening is sized so as to allow a piece of fruit to pass therethrough.
